(19) United States
(12) Patent Application Publication
(10) Pub. No.: US 2004/0133469 A1
(43) Pub. Date: Jul. 8, 2004

(54) System and method of promote website using Cycle Hits and Hits History

(75) Inventor: Dario Chang, Miami, FL (US)

Correspondence Address: DARIO CHANG, 4704 NW 114TH AVE UNIT 203, MIAMI, FL, 33178, US

(73) Assignee: Dario Chang, Miami (US)

(21) Appl. No.: 10/605,894

(22) Filed: Nov. 4, 2003

(51) Int. Cl. G06F 17/60

(52) U.S. Cl. 705/14

(57) ABSTRACT

System and method of promote website using Cycle Hits and Hits History, enabling promoters to manager their account and search listing, as influence a position in a pay placement search listing results generated by online marketing media as a search engine internet network

### BACKGROUND OF THE INVENTION

The Internet is a worldwide interconnection of computer networks that communicate using a common protocol. Millions of computers, from low end personal computers to high end super computers, are connected to the Internet

This transformation of the Internet into a global marketplace was driven in large part by the introduction of an information system known as the World Wide. The web is a unique distributed database designed to give wide access to a large universe of information. The database records of the web are in the form of documents known as “pages”. These pages reside on web servers and are accessible via the Internet.

The web is therefore a vast database of information dispersed across countless individual computer systems that is constantly changing and has no recognizable organization or morphology. Computers connected to the Internet may access the web pages via a program known as a browser, one powerful technique supported by the web browser is known as hyperlink, which permits web page authors to create links to other web pages which users can then retrieve by using simple point-and-click or Hits commands on the web browser.

The pages may be constructed in any one of a variety of formatting conventions, such as Hyper Text Markup Language (HTML), and include multimedia information content such as graphics, audio, and moving pictures programming code and flash. World Wide Web has the capability to introduce a worldwide base of consumers to businesses, individuals, and institutions seeking to Advertise their products and services to potential customers.

Furthermore, the ever increasing sophistication in the design of web pages, made possible by the exponential increase in data transmission rates and computer processing speeds, makes the web an increasingly attractive a new dimension of interactive media for Advertising, and other business purposes, as well as for the free flow of information.

Mechanisms, such as directories and search engines, have been developed to index and search the information available on the web and thereby help Internet users locate information of interest. These search services enable consumers to search the Internet for a listing of web sites based on a specific topic, product, or service of interest.

Search services are, after e-mail, the most frequently used tool on the Internet. As a result, web sites providing search services have offered Advertisers significant reach into the Internet audience and have given Advertisers the opportunity to target consumer interests based on keyword or topical search requests.

In a web-based search on an Internet search engine, a user enters a search term comprising one or more keywords, which the search engine then uses to generate, a listing of web pages that the user may access via a hyperlink.

The listing web page generated by the search engine, also have a list of pay Ads in text format with hyperlink related to the search term, usually this Ads display a similar copy, that is related to similar meta tag and title, and user seeking specific information click through many similar Ads, because of displayed Ads have very similar text copy, resulting in a negative conversion rate, as a result of click through charge to promoter base in irrelevant visit to their website.

Furthermore, current paradigms pay per performance Ads bid-for-position, pay-per-click pricing model prior art, however, rely upon processes for assigning a position to Ads that pay a bid on price to get a preferred position, with the problem that many popular terms are dominated for periods of time by big companies that dominate specific market for popular keywords related to their business, this scenario will increase to others less popular keywords as a result of the increasing rate listing in search engine, company with higher budget can cover the preferred position for their related keyword, without a real competition, as a result they pay a lower rate compare to their company budget and revenue, and smallest promoter pay a much higher rate in compare to their marketing budget, as the system of biding will push small promoters in to a unrealistic return on their investment, as the center and sprit of the biding pricing model market etymology is base in a marketplace that only allow players that are regulated by fundamental financial and marketing structure, (like currency and stock market for example.)

Furthermore, pay per performance Ads, bid-for-position, pay-per-click pricing model prior art, however, rely on unrealistic paradigms of concepts as: auto bid to eliminates any bid gaps, cruise control and automatic systems to make your bid. This pricing model, fail in the way wherein the returns on clients marketing investment ratio are negative for a big group of clients in a medium and long term position, as small individual compete with company with higher budgets and a better selling structure to offer their service and products. This situation happen especially in Ads related to keyword with high popularity, and will rise, due to the factor that internet small business, don't have to many media options to marketing their service. The main problem of this system relay in a fact, that the subject matter is not index to accommodate and regulate the different elements that compound this marketplace, which as become in the most diverse type of media, as players can be from a simple self-employed website owner, to a big company with a solid budget and marketing strategy.

Search engine often also generate irrelevant search results. The automated search technology that drives many search engines in the prior art rely in large part on complex, mathematics-based database search algorithms that select and rank web pages based on multiple criteria such as keyword density and keyword location. The search results generated by such mechanisms often rely on blind mathematical formulas and may be random and even irrelevant.

In Addition, search engines that use automated search technology to catalog search results generally rely on invisible web site descriptions, or “meta tags”, that are authored by web site promoters and are often very identical to the copy of pay Ads, confusing the searchers which mistake by click on many similar Ads, will have ineffective cost to the promoter that pay for each click.

This problem may be resolve also using the method of interactive Ads, with more information and interactivity with the searcher, where the information is not limited to title text, and promoter have even the option to introduce their service using a voice message, that users can listen before they click in the Ads, having in that way a higher rate of return on promoters investment.

Finally, search engines and pay Ads of the prior art are simply listing text Ads, with hyperlink, and web site owners may freely tag their sites as they choose. Consequently, some web site promoters or promoters insert popular search terms into their web site meta tags which are not relevant because by doing so they may attract Additional consumer confusing searchers attention and as a result pushing the biding market of pay Ads where small promoter ruing their budgets.

Search engines and web site directories may also rely on the manual efforts of limited editorial staffs to review web page information. Since comprehensive manual review and indexing of an unpredictable, randomly updated database such as the web is an impossible task, search engine results are often incomplete or out-of-date. Moreover, as the volume and diversity of Internet content has grown, on many popular web search sites, consumers must frequently click-through multiple branches of a hierarchical directory to locate web sites responsive to their search request, a process that is slow and unwieldy from the consumer's standpoint. Thus, the prior art search engines are ineffective for web page owners seeking to target their web exposure and distribute information to the attention of interested users on a current and comprehensive basis.

Furthermore, current paradigms for generating web site traffic, such as banner advertising, follow traditional Advertising paradigms and fail to utilize the unique attributes of the Internet. In the banner Advertising model, web site promoters seeking to promote and increase their web exposure often purchase space on the pages of popular commercial web sites. The web site promoters usually fill this space with a more distinguish Ads graphic, known as a banner, Advertising their own web site. The banner may act a hyperlink a visitor may click on to access the site. Like traditional Advertising, banner advertising on the Internet is typically priced on an impression basis with Advertisers paying for exposures to potential consumers. Banners may be displayed at every page access as general targeted and with no direct interaction with the user.

Nonetheless, impression-based Advertising inefficiently exploits the Internet's direct marketing potential, as the click-through rate, the rate of consumer visits a banner generates to the destination site, may be quite low. Web site promoters are therefore paying for exposure to many consumers who are not interested in the product or service being promoted, as most visitors to a web site seek specific information and may not be interested in the information announced in the banner. Likewise, the banner often fails to reach interested individuals, since the banner is not generally searchable by search engines and the interested persons may not know where on the web to view the banner.

Thus, the traditional paradigms of Advertising and search engine algorithms fail to effectively deliver relevant information via the World Wide Web to interested parties in a Cost-Effective manner. Internet Advertising can offer a level of target ability, a new dimension of interactivity, as new technologies with faster internet connections and computers are growing. With the proper tools, Internet Advertisers have the ability to target their messages to specific groups of consumers on Interactivity way, and receive prompt feedback as to the effectiveness of their Advertising campaigns.

Ideally, web site promoters should be able to control their placement, interact with the computer user in search result listings offering interactive information to searches that are relevant to the content of their web site.

Ideally, web site promoters should be able also to control their placement in a more dynamic market place, where different levels of and company to have the opportunity to get better placements on the listing search page result, as search engine have the ability to charge per listing, in relation to business size group.

The search engine functionality of the Internet needs to be focused in a new direction of interactivity where the user can listen to message of presentation related to the products and service target by search engine listing, to facilitate an on-line marketplace which offers consumers quick, easy and relevant search results while providing Internet Advertisers and promoters with a dynamic and cost effective way to target consumers. A consumer utilizing a search engine that facilitates this on-line market level place will find companies or businesses that offer the products, services, or information that the consumer is seeking.

In this on-line marketplace, companies selling products, services, or information need to take Advantage of technologies to expose their information in a more expressive and dynamic way on search result listing.

It is therefore an object of the present invention to provide a system and method to cover a dynamic system of placement, that allow a process of grouping accounts to be priced and placed, base on Hits History score value system, wherein the accounts with similar Hits History and Cycle Hits History can be grouped, tracked and store in a server database, wherein an automatic Hits History score generate a value that match similar accounts with a group, compromising a combination of score value that use at least one of theses elements: similar Hits History score value, period of time displayed score value, similar website traffic score value, similar budget size score value, similar terms and keywords value, similar type of business and/or company earning score value, similar sells season score value, rotation group score value, placement score value, popularity score value, account credit score value and rotation and exchange groups used with partners score value, related to accounts with previous rotation History between website partners, or search engine participants with rotation groups.

It is therefore an object of the present invention to provide a system and method using the element mention before to create a more complete Hits History score value, associated with accounts, and groups; wherein online marketing media can use a combination of this element to create and regulate a fair market place with different levels of markets as of groups of clients with similar Hits History score value, will have a cost effective placement and return on their investments.

A further object of the present invention promote website using Cycle Hits and Hits History system to influence a position in a pay placement search listing results generated by search engine, or other online marketing media, wherein each client will have an account before they get listed in search engine, each account will have one score value related to the Hits History and cycle of each account, the score value create groups of promoters with similar Hits History score value related to a search term or keywords, influencing a position on a result page listing list, group with higher Hits History will pay more to be listed on the search engine.

A still further object of the present invention that Individual Ads in each group are charged continue in proportion to the score related between Hits and specific account, to the end of the cycle which is determinate by the client, in relation to the maximum price Adjusted by the promoter in order to keep the Ad listed.

A further object of the present invention is to provide a system and method of market segmentation or group promoters into a price system related to their Hits History, and/or business size, of each client related to specify key search terms to the search engine so as to target their search result list placement to the search queries most relevant to their business.

It is also an object of the present invention to provide promoters with a search engine that permits such promoters to influence a higher placement in a search result, wherein promoters with similar Hits History integrate at least two group per page, to list their Ads in any format, as audio or video, or audio graphic, or combination of audio video, text and hyperlink Advertising.

It is therefore an object of the present invention to provide a system and method for list audio Advertising, video Advertising, video audio Advertising, combine with text, programming code, graphic and hyperlink that are used to post interactivity Advertising on a search result listing generated by an Internet search engine related to clients specified set of search terms.

It is still another object of the present invention to create a system and method of Advertising wherein Advertisers target the most interested consumers in an interactive way, as consumers will have the option to manipulate the Ads, by playing audio and video information related to search result generated by Advertiser-selected search terms.

It is therefore an object of the present invention allow also the creation of a common database of clients account, connected to server network to allow exchange group rotation system between search engine participants or on-line media marketing partners, wherein Advertiser can display their Ads in a rotation matter form one search engine to other, into a similar Hits History group, priced also for the option to be rotated into a list of search engine participants, same search terms and keyword, as rotation group allow the Ads to be rotated through a list of search engine participants comprising at least one of this elements: similar Hits History group, period of time displayed in each page participants, similar amount of Hits per each page participants, similar budget size, similar payments system.

It is yet another object of the present invention to create system and method of regulated market placement, with interactive Internet Advertising that is fair to consumers, Advertisers and search engine owners, as well as this new structure of price the Advertisement will allow a clients segmentation or groups, with similar Hits History that will rise individual their cost for the Ads to be listed continue, which allow to search engine owners to have better use of their listing space for each term relative to a group of client, and will allow smallest promoter to grow as their position will be more dynamic and auspicious related to the product of search.

It is also an object of the present invention to allow search engine the option to influence a position into the same group by a rotation system related to similar placement, to stimulate the marketplace or prevents over-delivery of Advertising through search result listings and possible over-billing of the Advertiser.

It is another object of the present invention to allow an automated Hits History management system that determinate the popularity of each keywords and term related to accounts, the amount of Hits per Ads for specific group will be translated in a score, that will determinate the price each Ads pay per amount of Hits, as the entry price level will be determinate by the group History, the system will also store the Hits History of each account, related to popularity of search listings for an Advertiser, each search listing including the associated search term and a cost per amount of Hits payable by the Advertiser will result each group score, the system then determines the entry cost for each group, including the search term associated with that group.

It is yet another object of the present invention allow also a database of clients waiting list, referring to clients how wait for a position, wherein clients are grouped into a similar group of keywords and term, as similar budget size, wherein search engine participants can post in client data base an offer related to the desire position for such group of clients related to desire keywords and term, this process may allow a biding between search engine participants (who offer the lowest price) to get a large group of clients, listed in their listing space, as a result, the offer can be base in entry price, or other offers to get a group of clients.

It is to be understood that many modifications and variations may be devised given the above description of the principles elements of the invention. It is intended that all such modifications and variations be considered as within the spirit, scope and subject matter of this invention.

### SUMMARY OF INVENTION

The present invention seeks provide a system and method for enabling a web site promoter using a computer network to influence a position within a search result list generated by an Internet search engine, or online marketing media.

More particularly, the present invention relates to a system and method for Advertisers to use Cycle Hits and Hits History, wherein a website promoter is charged in proportion to the Hits History score value of each webpage or account, increasing in this way a dynamic system of price for each keywords and promoters with similar Hits History, that are segmented in group related to their Hits History score value and/or business size, wherein each group have an score value that will influence the cost to keep the Ads listed, wherein groups and promoter with higher Hits History will have to pay a higher price to be listed, the cycle will end when promoters reach their top price to keep their Ad listed, as a result Ad is unlisted for a short period and listed again at the minimum entry fee for each group with similar Hits History.

Promoters without Hits History will list their Ad paying a minimum entry fee meanwhile they create a Hits History related to their account, as each client has one unique account identifier that could be related to their business, webpage, or tracking system used by marketing media, search engine and internet network.

Groups that compromise more elements, have a highest score value and a preferred position in the listing, online media or search engine network will also influence the score value of each element to balance the groups, as groups with low score value will have less elements and less preferred placement, as each group will have a number of assigned rotation placement spot, where any client can enter, paying an entry fee related to this group and type of spot, as price will rise in relation to display time and/or Hits History score the Ads get in the process.

This online competitive process, where each client or Ads is listed in the search engine, may be in specific group with similar Hits History score value, the accounts with similar Hits History and cycle Hits History can be grouped, tracked and stored in a server database, wherein an automatic Hits History score generates a value that match the account with a group, compromising a combination of Score Value that uses at least one of this elements: similar Hits History score value; period of time displayed score value; similar website traffic score value; similar budget size score value; similar terms and keywords value, similar type of business and/or company earning (accounting) score value; similar sell season score value; rotation group score value; placement score value; popularity score value; account credit score value and rotation and exchange groups used with partners value.

The embodiment of the present invention, provide a system and method that allow different variation to regulate and balance the online media market place: As allowing the option for the search engine to use rotation system into each group to create a dynamic placement, which also means that the price can be associate to number of rotation that client defines into the same group, exchange group in the same network, or group using partner's network.

As allowing also exchange group rotation system, compromising different search engine or partners connected to a common database of clients account, wherein Advertisers can display their Ads in a rotation matter form one search engine to other, into a similar Hits History group, priced for the option to be rotated into a list of search engine participants, same search terms and keyword, as rotation group allow the Ads to be rotated through a list of search engine participants comprising at least one of this elements: similar Hits History group, period of time displayed in each page participants, similar amount of Hits per each page participants, similar budget size. As allow also a common database of clients waiting list, referring to promoters that wait for a position when a group is full, or clients that determinate a range price they want to pay for displaying their Ad, where clients may be grouped by similar keywords and term, similar budget size, or range price determinate by clients; then the search engine participants with access to the database can post offers to the clients, allowing a biding process between search engine participants to get a large group of clients to be listed in their engine, as a result, the best search engine offer win a group of clients to optimize their listing space.

In a preferred embodiment of the present invention website promoter will be able to compete for a placement and pay for a position base in group of clients with similar Hits History score value, promoter will have also a regulated system to marketing their business, they will have more marketing options, and a system that allow a high end optimization and variations to get the best result and find solutions to current problems.

A Cycle Hits History will allow a dynamic and more rightful structure to place the Ads, as each cycle will reflect the budget of each client, and groups allowing a dynamic market level placement into search terms, clients, search engines, groups, and economic.

Search engine will also have a high end optimization of their listing space, as they will be able to charge promoter base in the marketing specifications of each individual group, not as they do now, where small prompters compete with large company with higher budget size and better marketing structure. This system will give a complete spectrum and engine to regulate and balance the growing online marketing media, special to search engine internet network.

### DETAILED DESCRIPTION

The composition of matter of the present invention cover a dynamic system of placement, that allows a process of grouping accounts to be priced and placed, base on Hits History score value system wherein the accounts with similar Hits History and cycle Hits History can be grouped, tracked and stored in a server database, wherein an automatic Hits History score generates a value that match the similar account with a group, compromising a combination of score value that uses at least one of these elements: Similar Hits History score value, referring to amount of Hits the Ads get by searchers, in relation to a search term, keywords, and group.

Period of time displayed score value, referring to continuous time the Ads has been listed, or will be listed into a group.

Similar website traffic score value; referring to traffic in (Who is info), or hits pre Ads and history data in search engine server.

Similar budget size score value, related to account balance or marketing budget.

Similar terms and keywords value, related also to similar meta tags, title and description.

Similar type of business and/or company earning (accounting) score value, related to similar industry, or Ads targeting the same industry, as business size also can be estimated by previous earning or projected earning of the company, as other accounting elements.

Similar sells season score value.

Rotation group score value, related to account with previous rotation History, into the same group, different groups, or between search engine participants.

Placement score value, related to Ads that have a repetitive position on a listing related to search term and keyword.

Popularity score value, wherein popularity terms and keywords are related to specific account or group.

Account credit score value, related to client payment and budgets History.

Rotation and exchange groups used with partners score value, related to accounts with previous rotation History between website partners, or search engine participants with rotation groups.

The combination of the elements mention before, create a more complete Hits History score value, associated with accounts, and groups.

Online marketing media can use a combination of this element to create and regulate a fair market place with different levels of markets as of groups of clients with similar Hits History score value, will have a more cost effective placement and return on their investments. The score value can be measured in points regulated by online marketing media where the Ads take place, and this point or measure can be computed in a server network database, where clients account information are stored.

Groups and promoters in preferred position, will have as a result a higher Hits History score value, and will pay a higher entry fee to list the Ad, as also the conversion ratio, of Hits per Ads, will generate a higher cost for the Advertiser in preferred position to keep the Ad listed.

For example: One client has a high score value of 9, as a result of a combination of many the elements mentioned before. Other clients have one score value of 6. The client that has a score value of 9, will have to pay a conversion ratio of 1 every 3 Hits his Ads get, the cost to keep the Ad listed will increase due to the number of Hits ratio, the price to keep the Ads listed will increase and multiply using this ratio, to the end of the cycle where the client unlisted the Ads.

The second client will have a less preferred position, but also will pay a lower conversion ratio, that can be 1 for every 5 Hits the Ad gets.

Price can be multiplied in relation to an estimate conversion ratio, related to the amount of Hits the Ads gets continuous in a single displaying cycle, the result of this process will create a Hits History score value, together with the other elements used to create a complete Hits History score value of each account and groups.

All groups will be associated also with most used keywords, Meta tags, title and descriptions associated with accounts, and groups. The ideal process of this association will use an automatic matching system, of sensitive case, to help search and match it with the promoters services, using a system wherein if the searcher fails in an amount of time to find a product or service, the search engine will have already, in a server network data base, a group of Ads associated with the keyword that can be more relevant to the object of search. In that case the search after a sensitive case of failing terms by searcher, the system can display in the page, a group of Ads, more relevant to the searcher.

Hits History score value system is designed to balance all positions, especially in listing associated with popular search terms, in this way the website promoter will be charged in proportion to the Hits History score value of each webpage or account. The system will increase by it self in a dynamic process of price related to each keywords and promoters with similar Hits History score value, where groups have a score value that will influence the cost to keep the Ads listed, wherein groups and promoter with higher Hits History will have to pay a higher price to be listed, to the end of the cycle when the promoter reaches their top price to keep their Ad listed.

The end of a listing cycle for one Ad associated to a category of keyword and search term, have as result that the Ad will be unlisted for a short period determinate by marketing media, the present invention optimizes search engine popularity listing space, allow a dynamic placement, allows that search engine owners get better use of the listing space, allows an optimization of price, allows that smallest company to get a better conversion rate and position, allows also that promoters start the listing paying the minimum entry fee for each group in relation to previous conversion rate performs and score value of each group.

In this system promoters without Hits History will list their Ad paying a minimum entry fee meanwhile they create a Hits History related to their account, as each client has one unique account identifier that will be related to their business, webpage, personal information, tracking system used by marketing media or search engine and internet network.

When new clients open one account they will enter information related to the elements of Hits History score value, the system by it self, will verify the information based on public information obtained by who is info, and will suggest a links of keywords and terms relevant to the client business. The new client may select the group where he wants to be, and the system by itself will make suggestion of groups relative to the client, based on the information that the client previously supplied. If the new client selects a group with higher Hits History score value, all the information will be reviewed to confirm the best tuning. The position into selected group will be automatically related to the Hits History score value elements: for example, budget size score value could be one of the elements selected by search engine to influence a position into each group, or a combination Hits History score value elements. Also there is the option of rotation into the same group, as search engines have the ability to determinate relevancy or each Hits History score value elements into each group, in order to balance the listing space in the most efficient way according to supply and demand related to listing page, groups, keywords and search terms.

Advertisements (or Ads) will appear on an online internet marketing media, as listing results list page, generated by search engine, as a result of generated search result list substantially in real time, in response to a search request from a searcher using a computer network, comprising: maintaining a database including Hits History groups associated with popularity of search listings; wherein each search listing is associated with a network location; at least one search term; that is associated with a Hits History group and Ads; related to grouped accounts with similar search term, keywords or description.

The Cycle Hits History began with the placement of Ads related to client account, wherein a client defines his budget to keep the Ads listed in the group, with the option to use caps related to a position into the group, as continuous Hits on the Ads create an Hits History score value that rises the price for the client to keep the Ads listed, when the client reach their top price or cap, the Ad is unlisted for a period of time, after that period, the Ad can be reenlisted into the group, paying a minimum entry fee related the average of each group previous Hits History score value, as cost to keep the Ad listed will rise again in relation to the score value generated and relative to the amount of Hits the Ad gets until the end of the cycle, allowing search engine or directory to have a dynamic use of listing space, especially in groups with high density associated to popular search terms or keywords, and allowing also clients to get a better conversion rate, based on previous Hits History score value elements.

The subject matter of the present invention also allows creation of a common database of clients, connected to server network to allow exchange group rotation system between search engine participants or online media marketing partners.

The exchange group rotation system compromises different search engines or partners connected to a common database of clients accounts, wherein Advertisers can display their Ads in a rotation matter from one search engine to other, into a similar Hits History group, priced for the option to be rotated into a list of search engine participants, same search terms and keyword, as rotation group allows the Ads to be rotated through a list of search engine participants compromising at least one of these elements: similar Hits History group, period of time displayed in each page participants(price time), similar amount of Hits per each page participants, similar budget size, similar payments system.

The subject matter of the present invention allows also a common database of clients waiting list, referring to promoters that wait for a position when a group is full, or clients that determinate a range price they want to pay for displaying their Ad associate to a group of search terms to choose from and position, what mean that promoter, can set a range price form clients interface where the price the want to pay associate to keywords, or previous position, or hits history value. The largest is the group, more interest will have search engine to give an offer to this group of clients. Clients may be grouped by similar keywords and term, similar budget size, or range price determinate by clients; then search engine participants with access to the database can post offers to the clients, this process allows a biding process between search engine participants to get a large group of clients to be listed in their engine, as a result, the best search engine offer win a group of clients.

A common database of clients will allow also search engine to set price range related to group of keywords, terms, and positions into a group, or page associate with keywords and terms. Others search engine participants will be able to bid down or up the offer to get a group of clients, or accommodate their listing space.

This variation will allow search engine to fill in search terms that are not very popular, as the can evaluate also the supply and demand for specific market, also, promoters will be able to adjust the markets in case some search terms and groups get to high in price, this variation accepts different kind of offers to adjust the market volume and regulate supply and demand in relation to search terms, promoters, search engine, groups, cycles hits history, or biding process.

The subject matter of the present invention allows other features and variations, as a method of interactive pay Ad placement in search engine network, using cycle Hits History, wherein each Ad give the user the possibility to use a button that plays or stops a voice message, video or graphic format, associated to a search term or keyword selected by the user on search engine page result on the internet network.

The method of place interactive Ads, compromises a metadata linked to a multimedia file data objects with; Swfs and Flash to display interactive low-bandwidth multimedia Ads. The liking of audio, video, multimedia data objects with metadata; may use current technology to incorporate and edit multimedia files and objects, such as Java applets; QuickTime, Flash, and Shockwave movies; and MP3 and other audio file formats. Sound files are handled very differently and inconsistently by different browsers, to improve consistency we save the sound files as SWFs.

The combination of interactivity may allow, that the searcher click a button on the Ad, and can listen to specific information related to the product that is being searched, if the searcher continues interested, he can Hits on the Ad and go to client website, who will have a higher conversion rate, as result that his Ads are more expressive and distinguish.

The client may have also the option to chat, from client account interface, to the user who seeks the Ad, allowing a high end of interactivity using Ads that speak to user, chats with user, show short media presentations, all this delegated to the user option to click a button and play a message that is related to keyword or search term generated by the search engine network.

Ads with a high end capacity of expression, compare to current method of Ads listed in search engine which are limited to text and hyperlinks, will allow a higher conversion rate, stimulating in a dynamic way this class of media.

The system and method of the present invention covers a subject matter of integrated marketing system that offer solutions to current problems in the field of this invention, from the method of displaying interactive Ads, to a complete system of placement and link options for this system, providing as result, fair balanced placement on search engine and online marketing media, for small and large businesses, as allowing a new dimension of interactivity and optimization of media space.

This new direction of interactivity wherein the user can listen to Ads or presentation related to the products and services targeted by search engine listing, to facilitate an online marketplace, offers to the consumers interactive, easy and relevant search results while providing internet Advertisers and promoters with a dynamic way to target consumers related to the term of search.

It is to be understood that many modifications and variations may be devised given the above description of the principle elements of the invention. It is intended that all such modifications and variations be considered as within the spirit, scope and subject matter of this invention.

1. A method and system for Advertisers using Cycle Hits and Hits History, wherein a website promoter is charged in proportion to the Hits History score value of each webpage or account, increasing in this way a dynamic system of price for each keywords; wherein promoters with similar Hits History are segmented in group related to their Hits History score value and/or business size, wherein each group have an score value that will influence the cost to keep the Ads listed, groups and promoter with higher Hits History will have to pay a higher price to be listed, the cycle will end when promoters reach their top price to keep their Ad listed, as a result Ad is unlisted for a short period and listed again at the minimum entry fee for each group with similar Hits History, as promoters without Hits History will list their Ad paying a minimum entry fee meanwhile they create a Hits History related to their account, as each client has one unique account identifier that could be related to their business, webpage, or tracking system used by marketing media, search engine and internet network. A system according to claim 1, wherein the accounts with similar Hits History and cycle Hits History can be grouped, tracked and stored in a server database, wherein an automatic Hits History score generates a value that match the account with a group, compromising a combination of Score Value that uses at least one of this elements: similar Hits History score value; period of time displayed score value; similar website traffic score value; similar budget size score value; similar terms and keywords value, similar type of business and/or company earning (accounting) score value; similar sell season score value; rotation group score value; placement score value; popularity score value; account credit score value and rotation and exchange groups used with partners value. The system and method according to claim 1, wherein pay Advertisements (or Ads) will appear in the listing results list page, generated by search engine, as a result of generated search result list substantially in real time, in response to a search request from a searcher using a computer network, comprising: maintaining a database including Hits History groups associated with popularity of search listings; wherein each search listing is associated with a network location; at least one search term; that is associated with a Hits History group and Ads; related to grouped accounts with similar search term, keywords or description. The system according to claim 1, wherein the Cycle Hits History began with the placement of Ads related to clients accounts, wherein a client defines his budget to keep the Ads listed in the group, with the option to use caps related to a position into the group, as continuous Hits on the Ads creates a score value that rises the price for the client to keep the Ads listed, when the client reaches their top price or cap, the Ad is unlisted for a period of time, after that period, the Ad can be listed again into the group, paying a minimum entry fee related to each group previous average Hits History score value, as cost to keep the Ad listed will rise again in relation to the score value and relative to the amount of Hits the Ad gets to the end of the cycle, allowing search engine or directory to have a dynamic use of listing space, especially in groups with high density associated to popular search terms or keywords. The system according to claim 1, of allowing the option for the search engine to use rotation system into each group to create a dynamic placement, which also means that the price can be associate to number of rotation that client defines into the same group, exchange group in the same network, or group using partner's network. The method of placement according to claim 1, of allowing exchange group rotation system, compromising different search engine or partners connected to a common database of clients account, wherein Advertisers can display their Ads in a rotation matter form one search engine to other, into a similar Hits History group, priced for the option to be rotated into a list of search engine participants, same search terms and keyword, as rotation group allow the Ads to be rotated through a list of search engine participants comprising at least one of this elements: similar Hits History group, period of time displayed in each page participants, similar amount of Hits per each page participants, similar budget size. The system according to claim 1, of allowing a common database of clients waiting list, referring to promoters that wait for a position when a group is full, or clients that determinate a range price they want to pay for displaying their Ad, where clients may be grouped by similar keywords and term, similar budget size, or range price determinate by clients; then the search engine participants with access to the database can post offers to the clients, allowing a biding process between search engine participants to get a large group of clients to be listed in their engine, as a result, the best search engine offer win a group of clients to optimize their listing space. The method of placement according to claim 1, wherein groups that compromise more elements, have a highest score value and a preferred position in the listing, online media or search engine network will also influence the score value of each element to balance the groups, as groups with low score value will have less elements and less preferred placement, as each group will have a number of assigned rotation placement spot, where any client can enter, paying an entry fee related to this group and type of spot, as price will rise in relation to display time and/or Hits History score the Ads get in the process. The system according to claim 1, of providing a placement using cycle Hits History and Hits History structure to price listing: on webpage, listings in a pay for placement database search system, search engine, directory, internet network, and other form of marketing media; Hits History compromises also a continuous rise of Ad's cost, in relation to each group Hits History, and value generated by continuous Hits per Ads into each group. The system according to claim 1, wherein Hits History Score Value system have the ability to integrate any part of their elements as an improvement, to currents online marketing media. Method of placement an interactive pay Ad in search engine internet network, using cycle Hits History, wherein each Ad gives the user the possibility to use a button that play or stop voice message, video or graphic format, related to search term and keyword selected by user on search engine page result on the internet network. The method of placement according to claim 11, wherein interactive Ads are linked to multimedia file data objects with metadata; as Swfs and Flash to display interactive low-bandwidth multimedia Ads, as a result of keyword search term generated by the search engine network, the Ads can use a button to play or stop a voice or video file related to the Ad for more info, as searcher can also click hyperlink to go to promoter website. It is claim that many modifications and variations may be devised given the above description of the principles elements of the invention and It is intended that all such modifications and variations be considered as within the spirit, scope and subject matter of this invention.
